(19) United States
(12) Patent Application Publication
(10) Pub. No.: US 2013/0331249 A1
(43) Pub. Date: Dec. 12, 2013

(54) Machine For The Production Of Tubes And Related Method

(71) Applicants: Mario Gioni Chiocchetti, Pieve di Compito (IT); Romano Maddaleni, Bientina (IT)

(72) Inventors: Mario Gioni Chiocchetti, Pieve di Compito (IT); Romano Maddaleni, Bientina (IT)

(73) Assignee: Fabio Perini S.P.A., Lucca (IT)

(21) Appl. No.: 13/980,949

(22) PCT Filed: Jan. 20, 2012
(86) PCT No.: PCT/IT12/00019

§ 371 Date: Aug. 22, 2013

(30) Foreign Application Priority Data
Jan. 25, 2011 (IT) FI2011A000014

(51) Int. Cl. B31C 3/00

(52) U.S. Cl. CPC B31C 3/00
USPC 493/299

(57) ABSTRACT

The machine includes a forming unit with a spindle around which one or more strips of web material are wound; an adhesive applicator to apply an adhesive on at least one surface of at least one strip of web material; a feed path of the at least one strip of web material from the adhesive applicator to the forming unit. The length of the feed path can be modified according to at least one opening parameter.

### TECHNICAL FIELD

The present invention concerns improvements to machines for the production of tubes by winding of at least one strip of web material, for example a strip of paper or cardboard.

### STATE OF THE ART

For the production of tubes, in particular, but not exclusively, for the production of tubular cores for winding web materials of various types, machines are used that receive at the inlet one or more strips of web material, for example paper or cardboard, and transform them into a continuous tubular article which, appropriately cut into sections, is transformed in turn into tubes used to form the winding cores for the formation of rolls of web material. The tubular articles of manufacture are in some cases also used for the production of containers or other articles.

Normally the strip or strips of web material are wound in a helical manner around a forming spindle. Examples of machines for the production of tubes with helical winding of one or more strips of paper or cardboard are described in US 2010/0204031, US 2010/0197475, US 2008/00093999, US 2007/0010387 and US 2006/0288558, U.S. Pat. No. 5,873,806.

Machines also exist for winding one or more strips of web material longitudinally, again for the purpose of forming a continuous tubular article which, when cut to size, is transformed into finished products.

In general the machines for the production of tubular articles from^{,} one or more strips of web material, also called corewinders, generally comprise a forming unit with a winding unit and a spindle around which one or more strips of web material are wound (longitudinally or helically). Upstream of the forming unit an adhesive applicator is provided which applies an adhesive on at least one surface of at least one strip of web material. Between the adhesive applicator and the forming unit a feed path is provided for the strip or strips of web material from the glue applicator to the forming unit.

As is known to those skilled in the art, these machines have some drawbacks due to the criticality of the adhesive drying process. In fact, the adhesive must be applied in the correct amount and in such a way that it can dry, guaranteeing setting in time before the continuous tubular article formed around the forming spindle is cut into single tubes. It is therefore necessary to carefully calibrate the type of adhesive, the quantity of adhesive applied, the temperature of the adhesive and the drying time. The humidity content of the adhesive is particularly important since, together with other parameters, it affects the drying and gluing process.

The parameters that affect the gluing can vary when the feed speed of the strip or strips of web material to the forming unit is modified. In fact, if an increase in the tube production speed is required, the time elapsing between the application of the adhesive and the beginning of the winding is reduced. The time required to perform the winding is also reduced and therefore, in short, the time elapsing between application of the adhesive and cutting of the continuous tubular article formed by the forming unit is reduced. The adhesive has less time to set. The consequence of this variation in operating conditions can be a gluing defect due to lack of reciprocal adhesion of the strips or portions of strips wound by the forming unit, with consequent defects in or discarding of the tubes obtained.

The gluing conditions can vary also independently of the production speed, for example due to an oscillation in the temperature of the adhesive or of the parts with which the strips of web material come into contact. Variation in ambient temperature, humidity content in the atmosphere or other environmental parameters can also significantly influence the behavior of the adhesive and therefore affect the quality of the end product.

### SUMMARY OF THE INVENTION

The present invention concerns a machine for the production of tubes by winding at least one strip of web material comprising: a forming unit with a winding unit and a spindle around which one or more strips of web material are wound; an adhesive applicator to apply an adhesive on at least one surface of at least one strip of said web material; a feed path of said at least one strip of web material from said adhesive applicator to said forming unit; wherein systems are provided suitable for overcoming wholly or partly the above-mentioned problems.

In particular, the object of a preferred embodiment of the invention is to provide a machine that allows easier adaptation to variations in operating conditions.

According to a different aspect, the invention provides a method for the production of tubular articles by winding of at least one strip of web material, which overcomes wholly or partly the drawbacks of the methods performed by the traditional machines.

Substantially, according to one aspect, a machine of the type indicated above is provided, according to the invention, with a feed path having a length modifiable according to at least one operating parameter.

In order to modify the length of the feed path of the strip of web material, in some embodiments of the invention a diverter device is provided along said feed path, the position of which can be modified to modify the length of said feed path. In this way the length of the feed path can be modified without modifying the distance between said applicator and said forming unit. This simplifies adjustment. The diverter device can comprise (or consist of) a diverter roller the position of which is advantageously adjustable to modify the path length of the strip of web material. For example, the diverter device can comprise a roller supported by a slider, a slide or a generic support which is mobile and adjustable, manually or preferably by means of an actuator. In advantageous embodiments, the actuator is connected to an automated control system.

In some embodiments, guide rollers with an adjustable distance are arranged along the feed path, to modify the length of said feed path. At least one of said rollers has an axis which is mobile with respect to the other roller or rollers, and constitutes or forms part of the diverter device.

Advantageously the guide rollers and the feed path are positioned so that a strip of web material guided around said guide rollers is in contact with said guide rollers with a first surface, opposite a second surface on which the adhesive is applied.

In some embodiments three guide rollers are provided. Preferably two of said three guide rollers are positioned with axes which are fixed and roughly parallel to each other, and the third roller is arranged with its axis oriented approximately 90° with respect to the axes of the first two guide rollers and is mobile with respect to them to vary the length of said feed path.

The length of the feed path can be modified manually, if necessary with the help of an actuator. Preferably, however, said length is modified automatically according to at least one operating parameter. For said purpose a control unit and an actuator controlled by said control unit can be advantageously provided, said actuator modifying the length of said feed path according to said at least one operating parameter under the control of said control unit.

The operating parameter can be selected from the group comprising: the humidity content of the adhesive in a position along said path; the feed speed of said at least one strip of web material; the quantity of adhesive delivered per surface unit on said at least one strip of web material; the weight per surface unit of said at least one strip of web material; the component material of said at least one strip of web material; the temperature of the adhesive; the type of adhesive; the composition of the adhesive; the ambient temperature; the ambient humidity.

According to a different aspect, the invention concerns a method for the production of tubular articles by winding a web material, comprising the steps of:
applying an adhesive on a first surface of at least one strip of web material;
feeding said strip of web material along a feed path towards a forming unit;
winding said at least one strip of web material to form a tubular article;
modifying a length of the feed path according to at least one operating parameter.

Further advantageous features and embodiments of the machine and the method according to the invention are described below and in the attached claims.

The invention can be applied also to machines that feed more than one glued strip to the forming unit. In this case it is advantageous to provide separate diverters for the different glued strips, and preferably a system for adjusting the path of each strip independently of the other. However, in simplified embodiments, one single system of adjustment of several paths, or also of one single common path for all the strips provided with adhesive can be foreseen. In other embodiments one single path can be provided equipped with a length adjustment system, and more precisely the path of the outermost glued strip. This can be the innermost strip of the tubular article obtained, if the glue is applied on the inner surface of the strip, or the second strip, starting from the outside, of the tubular article if the adhesive is applied on the outer surface.

### BRIEF DESCRIPTION OF THE DRAWINGS

The present invention will be better understood by following the description and the accompanying drawing, which shows practical non-limiting embodiments of the invention. More specifically:

FIG. 1 shows a front view of the machine according to the invention in a possible embodiment:

FIG. 2 shows a plan view according to of FIG. 1;

FIG. 3 shows a front view according to of FIG. 4 of the device for adjusting the length of the feed path of a strip of web material;

FIG. 4 shows a lateral view according to IV-IV of FIG. 3;

FIG. 5 shows a plan view according to V-V of FIG. 3;

FIGS. 6A, 6B show a modified embodiment in two operating set-ups;

FIG. 7 shows a schematic view according to VII-VII of FIG. 6A;

FIG. 8 shows a front view similar to the view of FIG. 1 of a further embodiment of the invention; and

FIG. 9 shows a front view similar to the view of FIG. 8, of a further embodiment of the invention.

### DETAILED DISCLOSURE OF EMBODIMENTS OF THE INVENTION

The invention will be described here below with reference to an application to a corewinder for the production of tubes by helical winding of two strips of web material around a forming spindle, with a per se known technique. However, it must be understood that the invention can be used also in machines that perform the winding of one single strip and also in machines that produce tubes by longitudinal winding instead of helical winding of one or more strips around a forming spindle. In longitudinal winding, one or more strips of the web material are fed in a direction parallel to the axis of the forming spindle, instead of inclined with respect to the axis of the forming spindle. The corewinders of this type are frequently used in the production of cylindrical or tubular articles intended for the manufacture of cylindrical containers. Also in these types of machines the above problems can occur, and these can be advantageously at least partly alleviated by the present invention.

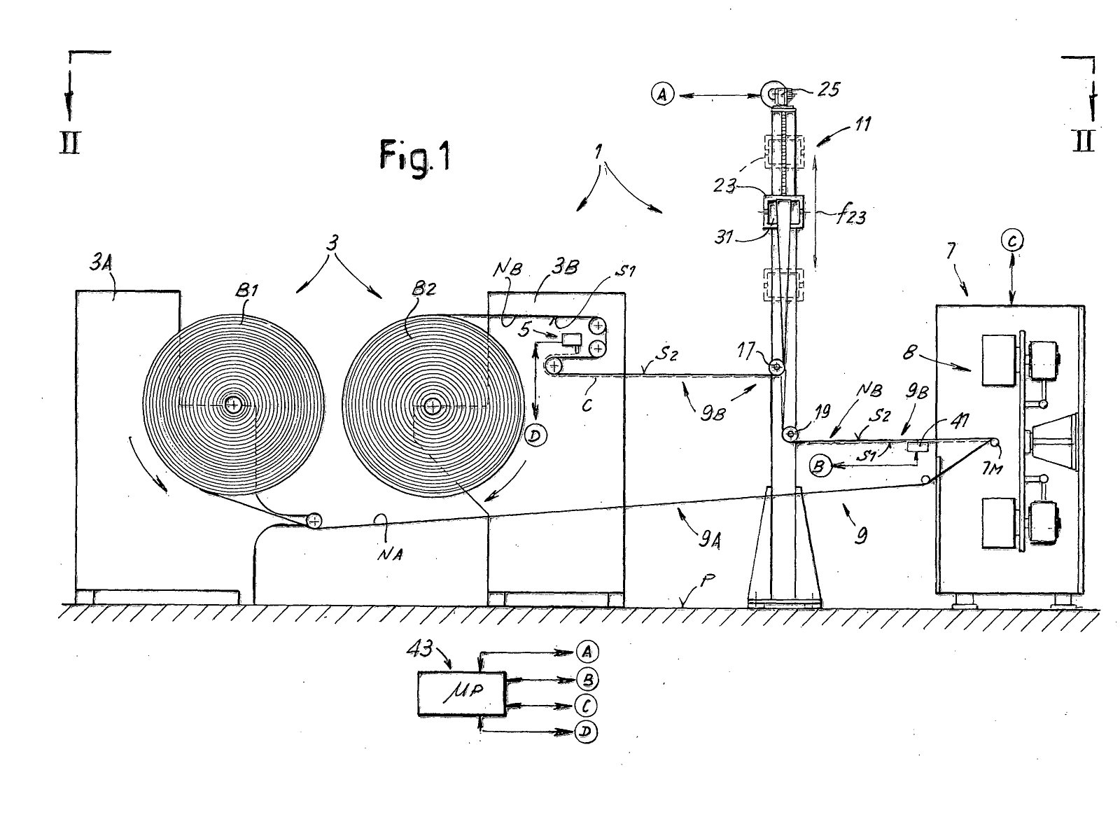

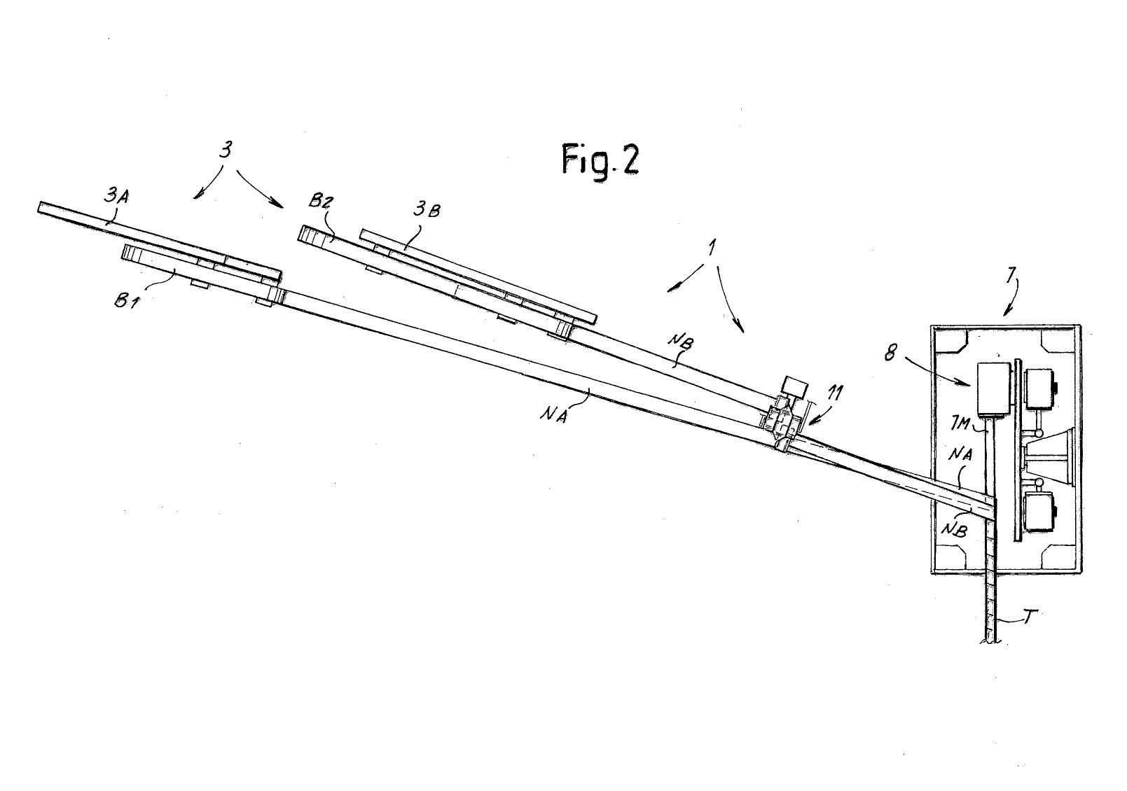

With initial reference to FIGS. 1 and 2 the machine, indicated by 1, actually consists of several spatially separate components which can be arranged on a floor P without reciprocal mechanical connection. The machine 1 comprises an unwinder unit 3 to unwind two reels B1 and B2 of two strips of web material NA and NB. The unwinder unit 3 comprises in particular two separate unwinders 3A and 3B to unwind two strips of web material from respective reels B1 and B2.

In the embodiment illustrated, an adhesive applicator 5, by way of example combined with the unwinder 3B, applies an adhesive on a first surface S1 of the strip of web material NB. In this exemplary embodiment the opposite surface S2 of the strip of web material NB is without adhesive. The web material NA is without adhesive on both the opposite faces or surfaces thereof.

The machine 1 furthermore comprises a corewinder indicated by 7 as a whole, provided with a forming unit 8 which will not be described in detail here and which can be designed in a manner known to those skilled in the art, for example as described in any one of the prior art documents cited in the introductory part of the present description, or in other documents concerning this technical field. Between the unwinder unit 3 and the corewinder 7 a double feed path develops indicated by 9 as a whole, along which the two strips of web material NA and NB are fed. More specifically, 9A indicates the feed path of the web material NA and 9B indicates the feed path of the web material NB.

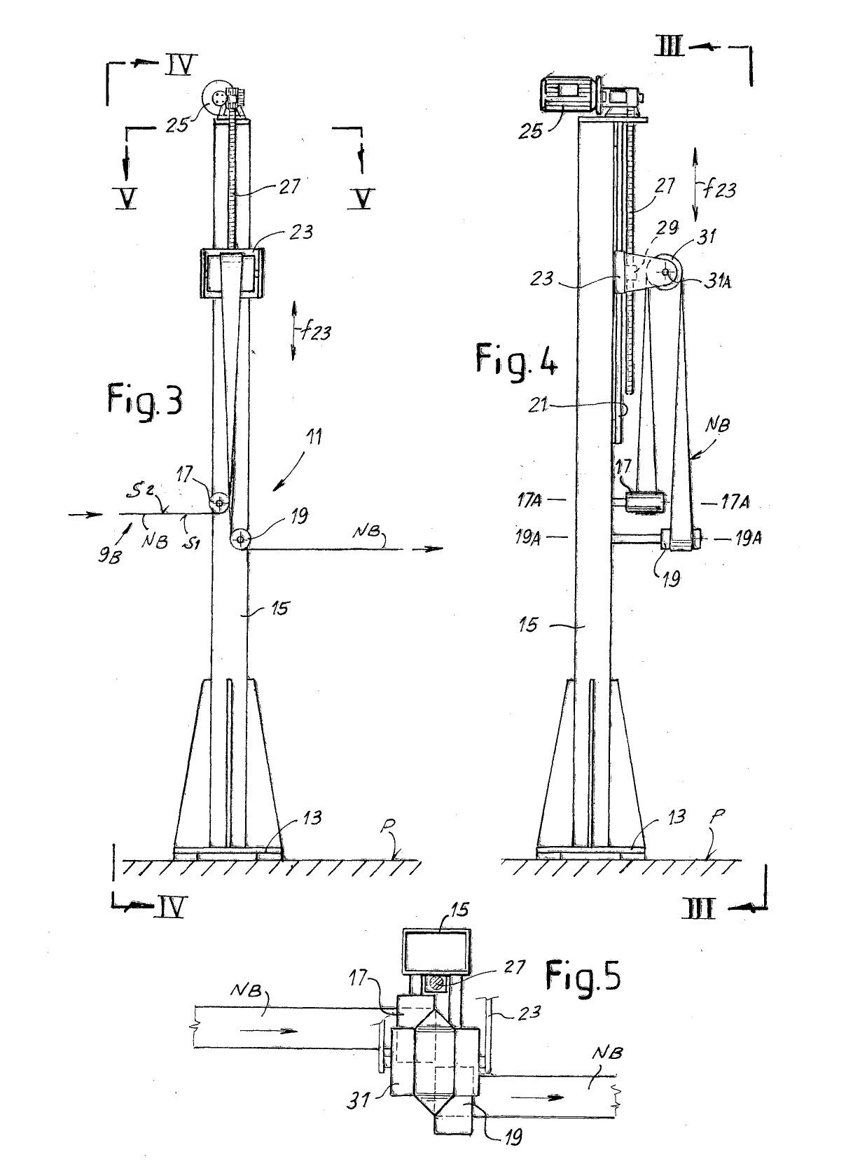

Along the feed path of the strip of web material NB a mechanism is provided, indicated by 11 as a whole, comprising a diverter device to modify the length of the feed path 9B of the strip of web material NB. The structure and functional features of the mechanism 11 will be described below in further detail with reference to FIGS. 3, 4 and 5.

In the embodiment illustrated, the mechanism 11 comprises a base 13 for resting on and securing to the floor P. In some advantageous embodiments of the invention, from the base 13 an upright 15 develops, along which a first guide roller 17 and a second guide roller 19 are arranged. In some embodiments the guide rollers 17 and 19 constitute the first two guide rollers of a set of three guide rollers for the strip of web material NB. Advantageously, in the example illustrated, the rollers 17 and 19 are arranged near to each other, slightly offset in the vertical direction to reduce the transverse dimension. Advantageously, the rollers 17 and 19 have substantially horizontal axes, preferably substantially parallel to each other.

Preferably above the rollers 17 and 19 on the upright 15 a guide 21 is arranged, which develops vertically parallel to the longitudinal development of the upright 15, throughout a portion thereof. A slide 23 can run along the guide 21. Preferably the movement of the slide 23 is controlled by an actuator, but it can also be controlled manually. In the example illustrated, the movement of the slide 23 according to the double arrow f23 is imparted by an actuator 25, for example a motor, preferably an electronically controlled electric motor. In the embodiment illustrated, the motor 25 is applied at the top of the upright 15, but it could be positioned in another way. For example the motor could be supported by the slide 23. It must be understood that the movement of the slide 23 can also be controlled by an actuator of another type, for example a cylinder-piston actuator preferably of hydraulic type, a linear electric motor or another suitable actuator. Also the position of the actuator can be different from the one illustrated in FIGS. 3 to 5.

The actuator 25 can transmit the movement to the slide by any type of transmission. In the embodiment illustrated, the electric motor 25 drives into rotation a threaded bar 27 which engages in a nut screw 29 supported by the slide 23 so that the rotation of the threaded bar 27 in one direction or the other causes raising or lowering of the slide 23 guided along the guide 21. This transmission system allows very accurate control of the position of the slide 23. Other transmissions can also be used, for example belt transmissions, preferably cogged belt transmissions.

In the embodiment illustrated, the slide 23 supports a third guide roller 31. Preferably the roller 31 is arranged with its axis 31A oriented at 90° with respect to the axes 17A and 19A of the rollers 17 and 19 respectively. Arranging the guide rollers 17, 19 and 31 in this way, only one of the two opposite surfaces of the strip of web material NB comes into contact with the rollers 17, 19 and 31. More specifically, as can be seen from FIG. 4, only the surface or face facing upwards of the strip of web material NB which arrives tangent to the roller 17 comes into contact with the latter, with the roller 31 and subsequently with the roller 19. This surface, indicated by S2, is the one without adhesive, as the adhesive applicator 5 has applied the adhesive C only on the lower face or surface Si which does not touch the guide rollers.

In a manner known per se, the strip of web material NB is subsequently fed to the corewinder 7, for example to wind around a forming spindle 7B according to a helical winding together with the strip of web material NA. In this exemplary embodiment, in which the tube T (FIG. 2) is formed by winding two strips of web material NA, NB, the latter are wound offset from each other. It is known to those skilled in the art that a tubular article can be obtained also by winding one single strip of web material with partially overlapping turns, to obtain a thinner and lighter tube, useful in some particular applications requiring a lower mechanical strength of the tubular article.

According to advantageous embodiments, along the feed path 9B of the strip of web material NB a humidity sensor 41 can be positioned which can detect the humidity content of the adhesive applied on the lower surface S1 of the strip of web material NB for the purposes described herein. Preferably the humidity sensor 41 is positioned between the device 11 and the corewinder 7, at a preferably fixed distance with respect to the forming unit 8 of the tubular article T in the corewinder 7.

The machine 1 can be controlled by a programmable electronic control unit, indicated by 43 as a whole. Advantageously the programmable electronic control unit 43 can be interfaced, as schematically indicated by the letters A, B, C, D, to the motor 25, to the adhesive applicator 5, to the humidity sensor 41 and to the corewinder 7. The latter is provided, in a manner known per se, with actuators which perform winding of the strips of web material and cutting of the tubular article obtained by winding of the strips. The actuators can be advantageously controlled by the programmable electronic control unit. The latter can be appropriately provided with a user interface, for example a keyboard and a monitor, for programming and/or modifying one or more machine operating parameters.

In this way via the programmable electronic control unit 43 the forming process of the tubular article or tube T can be controlled on the basis of a plurality of parameters. The programmable electronic control unit 43 can also be combined with other sensors, for example an ambient temperature sensor and/or an ambient humidity sensor.

The connection to the adhesive applicator can be used to adjust the temperature of the adhesive applied and/or the quantity of adhesive applied in the unit of time. The connection to the actuator 25 is used to control the movement according to the double arrow f23 of the slide 23. The connection to the humidity sensor 41 is used to acquire information on the humidity content of the adhesive C applied to the strip of web material NB. Lastly, the connection to the corewinder 7 allows control of the latter, for example by modifying the winding speed, the winding angle and other operating parameters.

As noted above, the machine operating parameters must be accurately set, especially in terms of the gluing conditions. In fact, the glue must have adequately set on the strip or strips of web material NA, NB when the tubular article T produced in a continuous manner by the corewinder 7 is divided into single sections. If not, the end product will be faulty and will have to be discarded. In order to obtain correct gluing, the feed speed of the strips to the corewinder 7, and the quantity and temperature of the adhesive applied by the adhesive applicator 5 must be determined. These parameters can vary, for example also depending on the material of which the strips NA, NB are made.

The residence time of the adhesive on the strip of web material NB before the beginning of winding depends on the feed speed and length of the feed path 9B. Also the winding time changes as the feed speed changes. If the operating parameters change during operation, for example if the feed speed of the strips of web material NA, NB changes, it may be necessary to intervene on the machine in order to modify the operating conditions so that the variation of the operating parameter or parameters does not affect correct gluing of the strips.

The mechanism 11 allows the operator to perform prompt effective adjustment which can compensate for fluctuation in the other operating parameters, such as the feed speed of the strips of web material NA, NB and consequent variation in the residence time of the adhesive C from the moment when it is applied through to cutting of the tubular article T into sections. This speed is set by the working conditions of the entire line of which the machine 1 forms a part. In fact the latter is normally connected to a web material converting line, for example paper web, such as tissue paper for the production of rolls of toilet paper. The production speed of the tubular article T therefore depends on the operating conditions of the line downstream and the winding speed of the corewinder 7 is closely linked to the operating conditions of the complex machines that form the roll winding line.

Suppose for example that for a certain working condition the correct operating point of the machine 1 has been found. At a certain feed speed V1 of the strips of web material NA, NB the optimal gluing condition has been obtained, having set the length of the feed path 9B of the strip of web material NB. Suppose now that the feed speed of the strips of web material NA, NB has to be increased to the value V2 (with V2>V1) to increase the productivity of the corewinder 7. This entails a reduction in the time available for correct gluing, since the adhesive C has less time between the time of application by the adhesive applicator 5 and the time in which the continuous tubular article is cut at the outlet of the corewinder 7. To remedy this circumstance, according to the invention the feed path 9B of the strip of web material NB is lengthened by moving the guide roller 31 away from the guide rollers 17 and 19 by operation of the motor 25. An opposite adjustment is made if, starting from a speed V1, the machine 1 has to be brought to an operating speed V3<V1.

The path length can be adjusted directly according to the feed speed. In other embodiments, the path length can be adjusted indirectly, via the measurement of another parameter, for example the humidity content of the adhesive directly upstream of the corewinder 7, measured by the humidity sensor 41. In this way it is possible to take account also of the effect of other parameters, such as ambient humidity, ambient temperature etc. Correct gluing is influenced mainly by the humidity content of the glue before winding of the strips of web material.

Other parameters can also affect the operating conditions of the machine 1, jeopardizing correct gluing of the web material forming the tube T. For example it is known that the operating temperature can modify the drying conditions of the adhesive C. This temperature can vary, especially during the machine start-up transients, as the various component parts are cold. In particular at the beginning of winding the forming spindle 7M is cold and therefore setting of the adhesive requires longer time, unless it arrives at the forming spindle 7M already partially dry, or with a lower humidity content. Again, this can be obtained by lengthening the feed path 9B of the strip of web material NB by moving the guide roller 31 away from the guide rollers 17 and 19. When the temperature of the machine increases gradually to the working temperature, an inverse adjustment is performed.

The above-mentioned adjustment can be obtained empirically, for example, by experimentally detecting a temperature increase and therefore determining a corresponding variation in the feed path 9B of the strip of web material NB in the transitory phase.

To take account of other parameters affecting the gluing conditions, other sensors can be interfaced to the programmable electronic control unit 43, for example ambient temperature and/or ambient humidity sensors. On the basis of the signals coming from these sensors, an automatic variation in the length of the path 9B of the strip of web material NB can be set.

Variations in the temperature of the adhesive which have been set or are a consequence of the variation of other non-controllable external parameters can entail similar requirements in terms of adjustment of the length of the feed path 9B of the strip of web material NB. An adhesive temperature sensor interfaced with the programmable electronic control unit 43 allows the latter to modify the position of the roller 31 as a result of fluctuations in this parameter.

In the embodiment illustrated, the humidity sensor 41 which detects the humidity content of the adhesive C directly upstream of the corewinder 7 can be advantageously used as the sole control parameter, since it is affected both by the ambient conditions and characteristics of the web material, and by the feed speed. It therefore allows simple effective control, modifying by means of the programmable electronic control unit 43 the position of the guide roller 31 according to the humidity content of the adhesive C directly upstream of the winding spindle 7M, thus maintaining the humidity content within a tolerance range pre-set around an optimal value.

The embodiment described so far features an automatic adjustment system of the length of the feed path 9B of the strip of web material NB via the acquisition of one or more operating parameters. However, in less advantageous but simpler and less expensive embodiments of the invention, manual adjustment of the length of the feed path 9B can be provided, again according to one or more operating parameters, typically the feed speed of the strip of web material NB, temperature, humidity and so on.

The embodiment illustrated describes a particularly advantageous feed path 9B of the strip of web material NB, with a diverter device comprising the slide 23, the guide roller 31 and the actuator 25. This embodiment is advantageous in terms of both overall dimensions and correct guiding of the strip of web material NB in any reciprocal position of the guide rollers 17, 19 and 31.

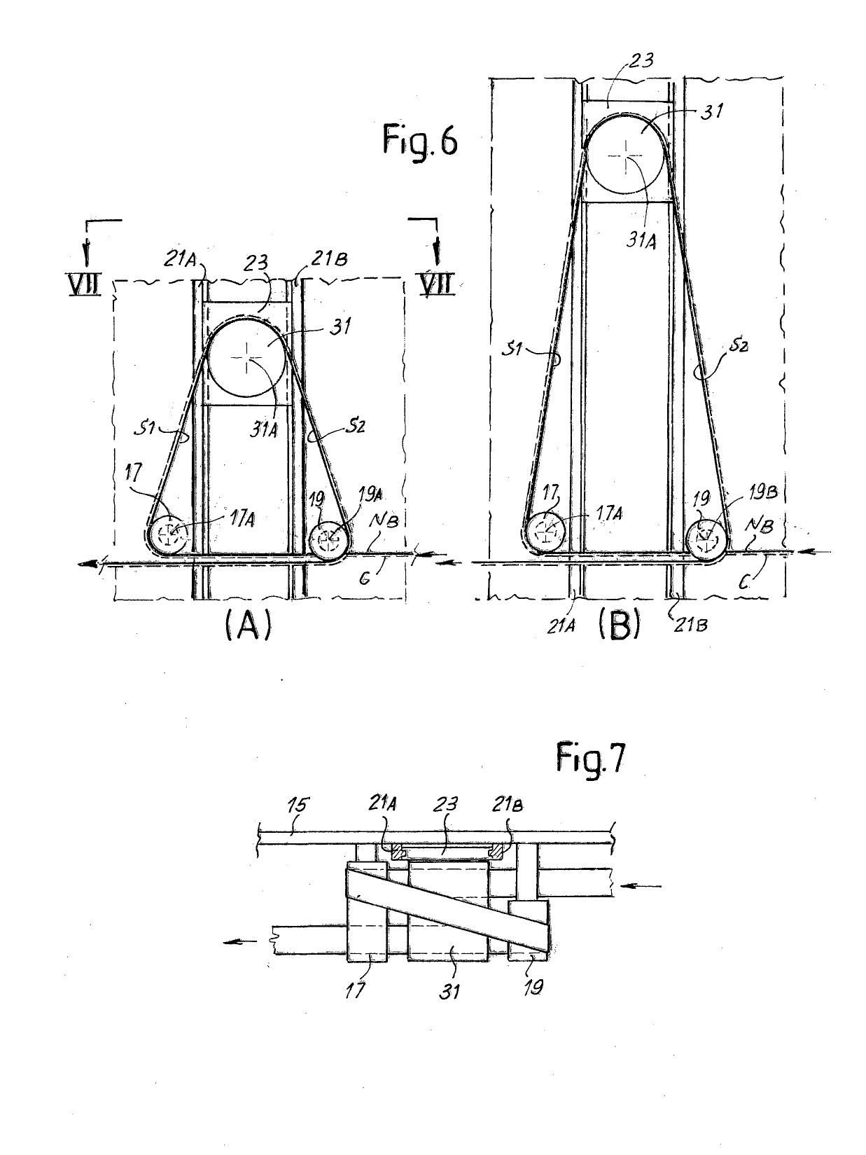

The diverter device can also be configured differently from the one illustrated in FIGS. 1 to 5. An example of alternative embodiment of the diverter device is illustrated in FIGS. 6 and 7. In this exemplary embodiment the diverter device still has a set of three guide rollers 17, 19 and 31. In this case the guide rollers 17, 19 and 31 are arranged with axes 17A, 19A and 31A parallel to one another. The path of the strip of web material NB is still such that the adhesive C applied on the surface S1 never comes into contact with the guide rollers 17, 19 and 31. In this exemplary embodiment the third guide roller 31 is mounted on a slide, again indicated by 23, guided in a pair of guides 21A, 21B integral with a supporting structure again indicated by 15. In some embodiments one or more of the rollers 17, 19 and 31 can be mounted with their axis floating so as to guarantee correct guiding of the strip of web material NB.

The embodiments described so far are particularly advantageous if applied to existing systems. It is sufficient to position a diverter device along the path existing between the unwinder and the forming unit, without structural modifications to either of them.

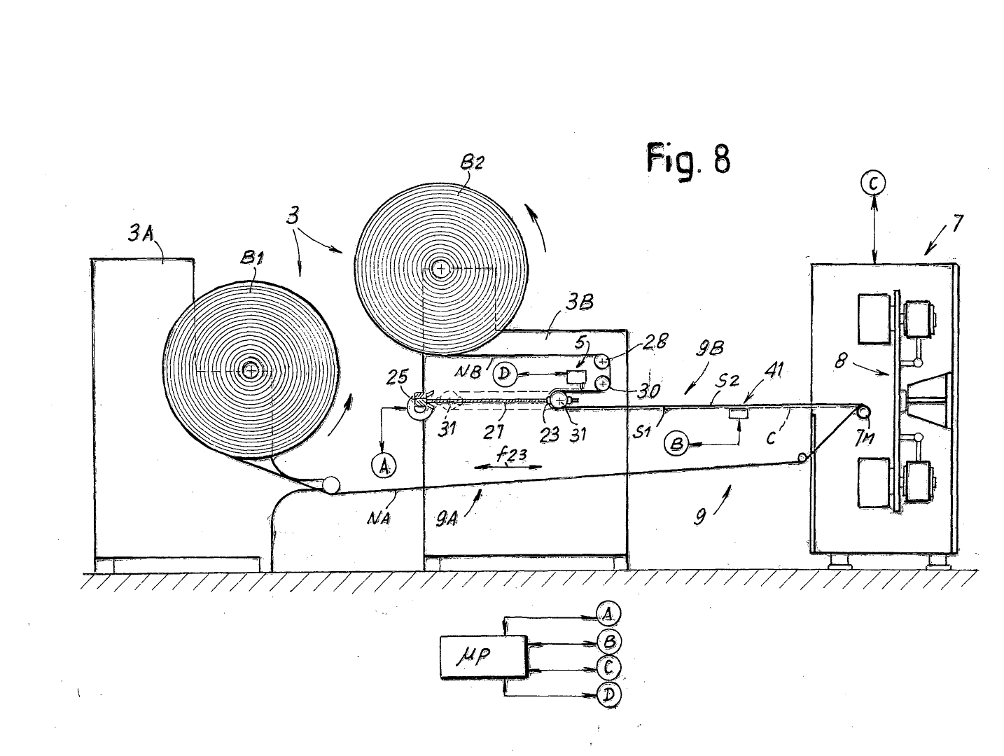

FIG. 8 shows a modified embodiment, in which a diverter device is provided comprising a diverter roller 31 supported by a structure of the unwinder unit 3 and more precisely, in the example illustrated, by the supporting structure of the unwinder 3B. Identical numbers indicate parts that are identical or corresponding to those of the example illustrated in FIGS. 1 to 6. The diverter roller 31 is supported by a slide or support 23 which, with a nut screw, engages with a threaded bar 27 operated by an actuator, for example an electric motor 25 controlled by the programmable electronic control unit 43. Upstream of the diverter roller 31, with respect to the feed direction of the strip of web material NB, two guide rollers 28 and 30 are arranged in sequence along the path of the strip of web material NB. Between the guide roller 30 and the diverter roller 31 the adhesive applicator 5 is positioned, which applies the adhesive in the section of strip of web material fed between the two rollers 30 and 31.

This embodiment is particularly simple and efficient, since it reduces the overall number of machine components and the overall dimensions. It is particularly advantageous if the diverter device is integrated in machines purposely designed to incorporate said device, while the examples previously described lend themselves in particular to improving existing machines without requiring any structural modification.

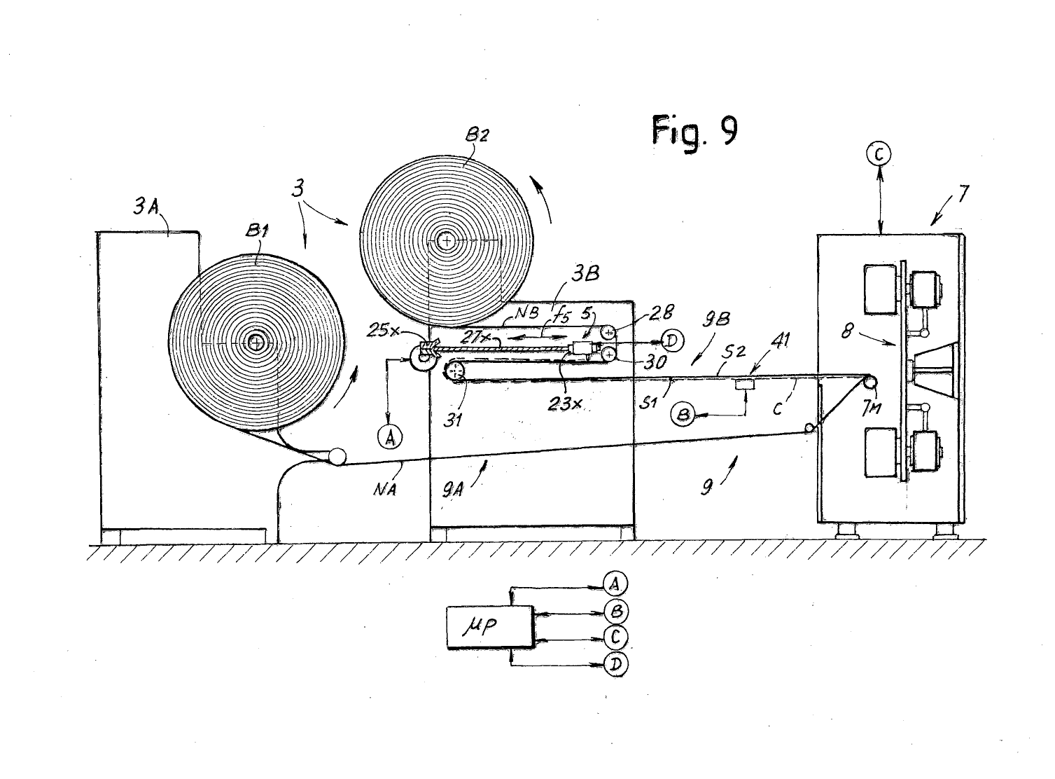

In the embodiments disclosed here before the length of the path along which the web material is fed is modified by acting on the actual total length of the web material between the respective reel and the forming unit. This, however, is not mandatory. Indeed, as noted above, what matters is the possibility of controlling and modifying (if required) the time during which the adhesive remains on the web material before winding. The length to be modified is therefore the length of the path between the adhesive applicator and the forming unit. This length can be modified also by keeping the trajectory of the web material fixed and by moving the position of the glue applicator along said trajectory. FIG. 9 shows an embodiment wherein the adhesive applicator 5 is moved under the control of an actuator and a threaded bar 27X, while the guiding rollers around which the web material S2 is entrained remain stationary. Arrow f5 indicates the displacement of the adhesive applicator 5. In some embodiments the adhesive applicator 5 can be supported by a slide 23X. The position of the adhesive applicator 5 is controlled by an actuator 25X via a threaded bar 27X. In this embodiment the length of the path between the adhesive applicator and the forming unit 8 is thus modifiable according to at least one operating parameter as disclosed above, by moving the position of the adhesive applicator. The overall trajectory of the web material is not changed, but the length of the feed path between the adhesive applicator and the forming unit is modified according to the position of the adhesive applicator with respect to the remaining parts of the machine.

It is understood that the drawing only shows an example provided solely as a practical demonstration of the invention, which can vary in the forms and arrangements without departing from the scope of the concept underlying the invention. The presence of any reference numbers in the attached claims is intended to facilitate reading of the claims with reference to the description and the drawing, and does not limit the scope of the protection represented by the claims.

1-23. (canceled)

24. A machine for producing tubes by winding at least one strip of web material comprising:
a forming unit with a spindle around which at least one strip of web material is wound;
an adhesive applicator for applying an adhesive on at least one surface of said at least one strip of web material;
a feed path for said at least one strip of web material from said adhesive applicator to said forming unit; wherein length of said feed path is modifiable according to at least one operating parameter.

25. The machine as claimed in claim 24, wherein along said feed path at least one diverter device is arranged, position of said at least one diverter device being modifiable to modify the length of said feed path.

26. The machine as claimed in claim 25, wherein said at least one diverter device comprises at least one guide roller for the at least one strip of web material, the position of said at least one guide roller being adjustable to modify the length of the feed path.

27. The machine as claimed in claim 25, wherein said at least one diverter device is controlled by an actuator to modify the position of said diverter device.

28. The machine as claimed in claim 25, wherein said at least one diverter device comprises a diverter roller positioned along said feed path, a guide roller for the at least one strip of web material being positioned upstream of said diverter roller, a section of path being defined between said guide roller and said diverter roller along which the adhesive applicator is positioned, distance between said guide roller and said diverter roller being adjustable to modify said length of the feed path.

29. The machine according to claim 24, wherein said adhesive applicator is movable to adjust position thereof with respect to a trajectory of said web material, to modify the length of said feed path.

30. The machine as claimed in claim 24, wherein the length of said feed path can be modified without modifying distance between said adhesive applicator and said forming unit.

31. The machine as claimed in claim 24, wherein said adhesive applicator is combined with an unwinding unit.

32. The machine as claimed in claim 25, wherein said adhesive applicator is combined with an unwinding unit, and said diverter device is supported by a structure of said unwinding unit.

33. The machine as claimed in claim 24, wherein guide rollers are arranged along said feed path at an adjustable distance to modify the length of said feed path.

34. The machine as claimed in claim 33, wherein said guide rollers and said feed path are positioned so that a strip of web material diverted around said guide rollers is in contact with said guide rollers with a first surface, opposite a second surface on which said adhesive applicator applies said adhesive.

35. The machine as claimed in claim 33, further comprising three guide rollers.

36. The machine as claimed in claim 35, wherein two of said three guide rollers are positioned with axes fixed and approximately parallel to each other, and a third roller of said three guide rollers is arranged with an axis thereof oriented at approximately 90° with respect to axes of first and second ones of the three guide rollers and is mobile with respect to the first and second ones of the three guide rollers to vary the length of said feed path.

37. The machine as claimed in claim 24, wherein the length of said feed path is modified automatically according to said at least one operating parameter.

38. The machine as claimed in claim 24, further comprising a control unit and an actuator controlled by said control unit, said actuator modifying the length of said feed path according to said at least one operating parameter under the control of said control unit.

39. The machine as claimed in claim 24, wherein said at least one operating parameter is at least one of humidity content of the adhesive in a position along said feed path; advancing speed of said at least one strip of web material; quantity of adhesive delivered per surface unit onto said at least one strip of web material; weight per surface unit of said at least one strip of web material; component material of said at least one strip of web material; temperature of the adhesive; type of adhesive; composition of the adhesive; ambient temperature; and ambient humidity.

40. The machine as claimed in claim 24, further comprising a humidity sensor for detection of humidity content of the adhesive applied on said at least one strip of web material along said feed path.

41. The machine as claimed in claim 25, further comprising a humidity sensor for detecting humidity content of the adhesive applied on said at least one strip of web material, arranged along said feed path; and wherein said humidity sensor is positioned between said diverter device and said forming unit.

42. A method for producing tubular articles by winding of a web material, comprising steps of:
applying an adhesive on a first surface of at least one strip of web material;
feeding said at least one strip of web material along a feed path between a position of adhesive application and a forming unit;
winding said at least one strip of web material to form a tubular article;
wherein a length of said feed path is modified according to at least one operating parameter.

43. The method as claimed in claim 42, further comprising guiding said at least one strip of web material around at least one diverter device, and modifying position of said diverter device to set a length of the feed path to a selected value.

44. The method as claimed in claim 42, further comprising modifying said length of said feed path by adjusting the position of an adhesive applicator along a trajectory of advancement of said web material.

45. The method as claimed in claim 42, further comprising detecting said at least one operating parameter during the producing of said tube and automatically modifying the length of said feed path according to said at least one operating parameter.

46. The method as claimed in claim 42, wherein said at least one parameter is at least one of humidity content of the adhesive in a position along said feed path; feed speed of said at least one strip of web material; quantity of adhesive delivered per surface unit onto said at least one strip of web material; weight per surface unit of said at least one strip of web material; component material of said at least one strip of web material; temperature of the adhesive; type of adhesive; composition of the adhesive; ambient temperature; ambient humidity.
